(19) United States
(12) Patent Application Publication
(10) Pub. No.: US 2010/0219685 A1
(43) Pub. Date: Sep. 2, 2010

(54) VOLTAGE SUPPLY CIRCUIT

(75) Inventors: Yoshinori Horikawa, Osaka (JP); Tomohiro Kume, Osaka (JP); Takuya Ishii, Takuya (JP); Taichi Ikedo, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/708,915

(22) Filed: Feb. 19, 2010

(30) Foreign Application Priority Data
Feb. 27, 2009 (JP) 2009-045977

(51) Int. Cl. H02J 1/00

(52) U.S. Cl. 307/31

(57) ABSTRACT

In the voltage supply circuit, a reference voltage generating circuit generates a reference voltage. An operational amplifier circuit generates an output voltage on the basis of the reference voltage. A selection circuit has at least two first terminals to select one of the first terminals and to generate a passed output voltage representing the output voltage passed through the first terminal selected. A second terminal receives the passed output voltage and is capable of outputting the passed output voltage to a load circuit. A detection circuit detects a magnitude of the passed output voltage and generates a detection voltage. The selection circuit selects a voltage corresponding to the passed output voltage generated from among at least two of the detection voltages and generates a detection voltage representing the detection voltage selected. The operational amplifier circuit decreases the difference between the reference voltage and the selected detection voltage.

### BACKGROUND OF THE INVENTION

1. Field of Invention

The present invention relates to a voltage supply circuit for supplying predetermined DC voltages to electronic circuit blocks inside various kinds of electronic appliances.

2. Description of Related Art

In recent years, as mobile appliances typified by mobile phones become multifunctional, the need for supplying different power source voltages and different reference voltages to various electronic circuit blocks (hereafter referred to as load circuits) is increasing. For this purpose, a voltage supply circuit being used for such load circuits requires multiple power source circuits.

As a conventional example of this kind of voltage supply circuit, for example, a voltage supply circuit disclosed in Japanese Laid-open Patent Publication No. 1999-65685 is available. FIG. 7 is a circuit diagram showing the voltage supply circuit according to this conventional example. In FIG. 7, the voltage supply circuit according to the conventional example contains operational amplifier circuits 21p, 22p and 23p, a first constant current circuit 24p, a second constant current circuit 25p, a third constant current circuit 26p, and a reference voltage generating circuit 20p. The operational amplifier circuits 21p to 23p generate voltages Vo1p, Vo2p and Vo3p. The operational amplifier circuits 21p to 23p supply power from the output terminals 11p, 12p and 13p thereof to load circuits, respectively. The first constant current circuit 24p, the second constant current circuit 25p and the third constant current circuit 26p pass constant currents for operating the respective operational amplifier circuits. The reference voltage generating circuit 20p supplies a reference voltage Vrefp to the respective operational amplifier circuits. A power source voltage Vccp is supplied from a power source terminal 1p to the above-mentioned respective circuits.

The operational amplifier circuits 21p to 23p and the second constant current circuit 25p can operate when the power source voltage Vccp is supplied. On the other hand, the cut terminals Tc1p and Tc3p of the first constant current circuit 24p and the third constant current circuit 26p are connected to the ground line side. The activation or deactivation of the constant current circuits 24p and 26p can be set depending on whether the cut terminals are grounded or not. A constant current is supplied to the reference voltage generating circuit 20p from the second constant current circuit 25p, whereby the reference voltage generating circuit 20p generates the reference voltage Vrefp from the constant current. The reference voltage Vrefp is input to the non-inverting input terminals of the operational amplifier circuits 21p to 23p. Feedback resistors 42p, 44p and 46p are connected between the output terminals and the inverting input terminals of the operational amplifier circuits 21p, 22p and 23p, respectively, and grounding resistors 43p, 45p and 47p are connected between the inverting input terminals of the operational amplifier circuits 21p, 22p and 23p and the ground, respectively. From the reference voltage Vrefp, the operational amplifier circuits 21p, 22p and 23p generate DC constant voltages Vo1p, Vo2p and Vo3p determined using the feedback resistors 42p, 44p and 46p and the grounding resistors 43p, 45p and 47p, respectively, as described below. It is assumed that the resistance values of the resistors 42p, 43p, 44p, 45p, 46p and 47p are R2p, R3p, R4p, R5p, R6p and R7p, respectively.

Vo1p=Vrefp×(R2p+R3p)/R3p

Vo2p=Vrefp×(R4p+R5p)/R5p

Vo3p=Vrefp×(R6p+R7p)/R7p

The operational amplifier circuit 21p is configured so that, when the current supply from the first constant current circuit 24p is cut off, the voltage output from the operational amplifier circuit 21p is stopped. Similarly, the operational amplifier circuit 23p is configured so that, when the current supply from the third constant current circuit 26p is cut off, the voltage output from the operational amplifier circuit 23p is stopped. In other words, whether the DC constant voltages Vo1p and Vo3p are output or not can be determined by switching depending on whether the cut terminals Tc1p and Tc2p are grounded or opened, respectively. Hence, when the voltage output from each of the output terminals 11p and 13p is stopped, power consumption due to the flow of unnecessary current in the circuits for generating the power source voltages therefor does not increase, whereby efficient operation can be attained.

### SUMMARY OF THE INVENTION

However, in the voltage supply circuit according to the conventional example described above, since the current supply to the operational amplifier circuit is cut off when the power source voltage output is stopped, there is a problem in which a certain time is required when the power source voltage output is supplied subsequently. Furthermore, in the case that it is not necessary to perform voltage supply to two or more load circuits at a time, a configuration including multiple operational amplifier circuits has a problem in which the usage efficiency of the voltage supply circuit is low and the size thereof increases.

For the purpose of solving the problems encountered in the voltage supply circuit according to the conventional example, an object of the present invention is to provide a voltage supply circuit capable of being reduced in size and capable of quickly raising a voltage to be output in the case that it is not necessary to perform voltage supply to two or more load circuits at a time.

In order to attain the above-mentioned object, the voltage supply circuit according to the present invention comprises a reference voltage generating circuit operable to generate a predetermined reference voltage; an operational amplifier circuit operable to generate an output voltage on the basis of the reference voltage; a selection circuit having at least two first terminals and controlled on the basis of a control signal from a control section to select one of the first terminals and to generate a passed output voltage representing the output voltage passed through the first terminal selected; a second terminal operable to receive the passed output voltage and capable of outputting the passed output voltage to a load circuit; and a detection circuit operable to detect the magnitude of the passed output voltage and to generate a detection voltage, wherein the selection circuit is controlled on the basis of the control signal and selects a voltage corresponding to the passed output voltage from among at least two of the detection voltages and generates a selected detection voltage representing the detection voltage selected, and the operational amplifier circuit decreases the difference between the reference voltage and the selected detection voltage.

In the case that voltages different from one another are supplied to two or more load circuits, one voltage at a time, with the use of the selection circuit, the voltage supply circuit according to the present invention can be configured by using only one operational amplifier circuit. Hence, it is possible to reduce the size, power consumption and cost of the voltage supply circuit. Furthermore, a supply-stop state feedback path is provided to maintain the operational amplifier circuit at its activated state at all times, whereby, when a voltage is started to be supplied to a load circuit subsequently, the voltage to be supplied can be raised quickly.

### BRIEF DESCRIPTION OF THE DRAWINGS

FIG. 1 is a circuit diagram showing a voltage supply circuit according to a first embodiment of the present invention;

FIG. 2A is a circuit diagram showing the selection circuit of the voltage supply circuit according to the first embodiment of the present invention;

FIG. 2B is a relationship diagram showing the selection relationship of the selection circuit of the voltage supply circuit according to the first embodiment of the present invention;

FIG. 3 is a circuit diagram showing a voltage supply circuit according to a second embodiment of the present invention;

FIG. 4 is a circuit diagram showing the selection circuit of the voltage supply circuit according to the second embodiment of the present invention;

FIG. 5 is a circuit diagram showing a voltage supply circuit according to a third embodiment of the present invention;

FIG. 6 is a circuit diagram showing a voltage supply circuit according to a modified example of the third embodiment of the present invention; and

FIG. 7 is a circuit diagram showing the voltage supply circuit according to the conventional example.

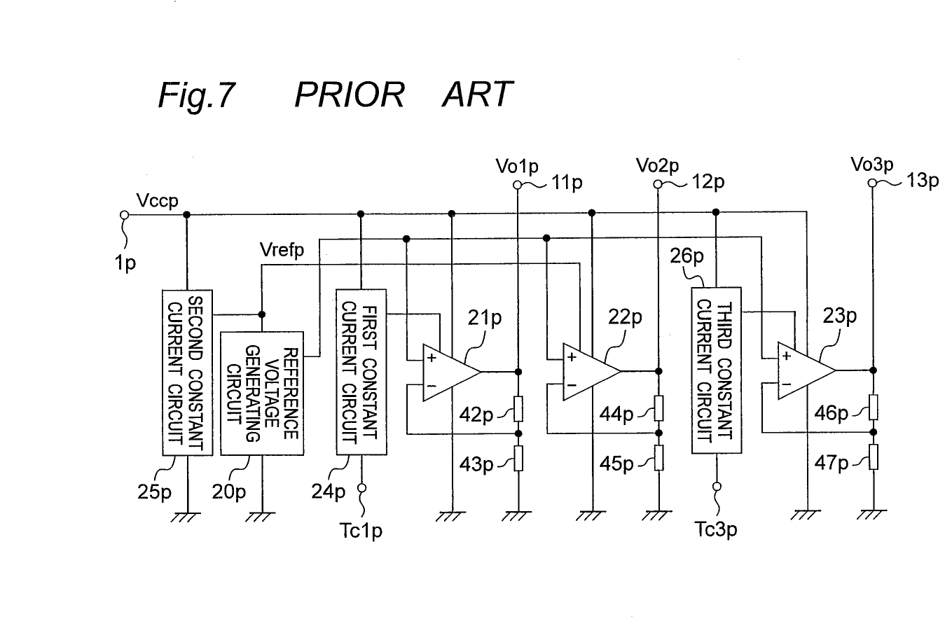

### DETAILED DESCRIPTION OF THE PREFERRED EMBODIMENTS

Some examples of the best modes for embodying the present invention will be described below referring to the accompanying drawings. In the drawings, components having substantially the same configurations, operations and effects are designated by the same reference codes. In addition, numbers described below are all exemplified to specifically explain the present invention, and the present invention is not limited by the exemplified numbers. Furthermore, the logic levels represented by high/low levels or the switching states represented by ON/OFF states are used to specifically exemplify the present invention, and similar results can also be obtained by variously combining exemplified logic levels or switching states. Moreover, connections between the components are exemplified to specifically explain the present invention, and connections for achieving the functions of the present invention are not limited to these connections. Still further, although embodiments described below are configured using hardware and/or software, a configuration implemented by hardware can also be implemented by software, and a configuration implemented by software can also be implemented by hardware.

### First Embodiment

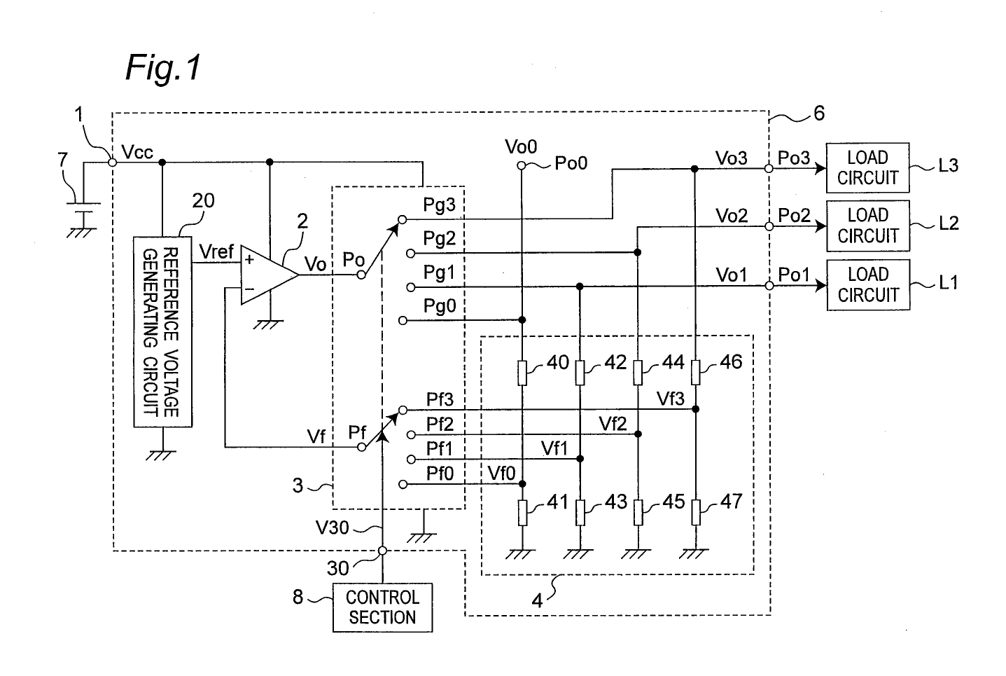

FIG. 1 is a circuit diagram showing a voltage supply circuit according to a first embodiment of the present invention. A DC voltage source 7, such as a battery, supplies an input DC voltage Vcc to a voltage supply circuit 6 through the input terminal 1 of the voltage supply circuit 6. A control section 8 generates a control signal V30 for controlling the voltage supply circuit 6. The voltage supply circuit 6 converts the input DC voltage Vcc into voltages Vo1, Vo2 and Vo3 on the basis of the control signal V30 and outputs the voltages Vo1, Vo2 and Vo3 from the output terminals Po1, Po2 and Po3 of the voltage supply circuit 6, respectively. Load circuits L1, L2 and L3 receive the output voltages Vo1 to Vo3, respectively, and perform desired functions. The voltage supply circuit 6 has two states: a supply state and a supply stop state. In the supply state, the voltage supply circuit 6 receives the input DC voltage Vcc and supplies one of the output voltages to either one of the load circuits L1 to L3. In the supply stop state, the voltage supply circuit 6 receives the input DC voltage Vcc, but does not supply the output voltages to any one of the load circuits L1 to L3.

The voltage supply circuit 6 includes a reference voltage generating circuit 20, an operational amplifier circuit 2, a selection circuit 3, the output terminals Po1 to Po3, and a detection circuit 4. The reference voltage generating circuit 20 operates by using the input DC voltage Vcc as a power source voltage and generates a predetermined reference voltage Vref. The operational amplifier circuit 2 operates by using the input DC voltage Vcc as a power source voltage, receives the reference voltage Vref at the non-inverting input terminal thereof and generates an output voltage Vo to the input terminal Po (described later) of the selection circuit 3 on the basis of the reference voltage Vref.

The selection circuit 3 has the input terminal Po and output terminals Pg0, Pg1, Pg2 and Pg3. The selection circuit 3 receives the control signal V30 through a control terminal 30 and selects either one of the output terminals Pg0 to Pg3 on the basis of the control signal V30. Furthermore, the selection circuit 3 passes the output voltage Vo through a selected one of the output terminals Pg0 to Pg3 and generates a passed output voltage Vg0, Vg1, Vg2 or Vg3 representing the passed output voltage Vo.

The detection circuit 4 includes resistors 40, 41, 42, 43, 44, 45, 46 and 47 having resistance values R40, R41, R42, R43, R44, R45, R46 and R47, respectively. The output terminal Pg0 of the selection circuit 3 is connected to a dummy output terminal Po0 and to one terminal of the resistor 40. The other terminal of the resistor 40 is connected to one terminal of the resistor 41 and to the input terminal Pf0 of the selection circuit 3, and the other terminal of the resistor 41 is grounded. The output terminal Pg1 of the selection circuit 3 is connected to the output terminal Po1 of the voltage supply circuit 6 and to one terminal of the resistor 42. The other terminal of the resistor 42 is connected to one terminal of the resistor 43 and to the input terminal Pf1 of the selection circuit 3, and the other terminal of the resistor 43 is grounded. Similarly, the output terminal Pg2 of the selection circuit 3 is connected to the output terminal Po2 of the voltage supply circuit 6 and to one terminal of the resistor 44. The other terminal of the resistor 44 is connected to one terminal of the resistor 45 and to the input terminal Pf2 of the selection circuit 3, and the other terminal of the resistor 45 is grounded. Similarly, the output terminal Pg3 of the selection circuit 3 is connected to the output terminal Po3 of the voltage supply circuit 6 and to one terminal of the resistor 46. The other terminal of the resistor 46 is connected to one terminal of the resistor 47 and to the input terminal Pf3 of the selection circuit 3, and the other terminal of the resistor 47 is grounded. The output terminals Po1 to Po3 can be connected to the load circuits L1 to L3, respectively. On the other hand, the dummy output terminal Po0 cannot be connected to any one of the load circuits L1 to L3.

The output terminal Po1 receives the passed output voltage Vg1 and can output the passed voltage Vo1 approximately equal to the passed output voltage Vg1 to the load circuit L1. The output terminal Po2 receives the passed output voltage Vg2 and can output the passed voltage Vo2 approximately equal to the passed output voltage Vg2 to the load circuit L2. The output terminal Po3 receives the passed output voltage Vg3 and can output the passed voltage Vo3 approximately equal to the passed output voltage Vg3 to the load circuit L3. The output terminals Po1 to Po3 do not receive the passed output voltage Vg0.

The detection circuit 4 detects the magnitudes of the passed output voltages Vg0, Vg1, Vg2 and Vg3 and generates detection voltages Vf0, Vf1, Vf2 and Vf3, respectively. More specifically, the detection circuit 4 divides the passed output voltage Vo0 by multiplying the output voltage Vo0 by R41/(R40+R41), thereby generating the detection voltage Vf0 at the input terminal Pf0. Similarly, the detection circuit 4 divides the passed output voltage Vo1 by multiplying the output voltage Vo1 by R43/(R42+R43), thereby generating the detection voltage Vf1 at the input terminal Pf1. Similarly, the detection circuit 4 divides the passed output voltage Vo2 by multiplying the output voltage Vo2 by R45/(R44+R45), thereby generating the detection voltage Vf2 at the input terminal Pf2. Similarly, the detection circuit 4 divides the passed output voltage Vo3 by multiplying the output voltage Vo3 by R47/(R46+R47), thereby generating the detection voltage Vf3 at the input terminal Pf3. Hence, Expression 1, Expression 2, Expression 3 and Expression 4 are established.

Vf0=Vo0×R41/(R40+R41) (1)

Vf1=Vo1×R43/(R42+R43) (2)

Vf2=Vo2×R45/(R44+R45) (3)

Vf3=Vo3×R47/(R46+R47) (4)

The selection circuit 3 selects one of the detection voltages Vf0 to Vf3 corresponding to the passed output voltages Vg0 to Vg3 to be generated, on the basis of the control signal V30, and generates a selected detection voltage Vf representing the selected detection voltage at the output terminal Pf of the selection circuit 3. More specifically, in the case that the output terminal Pg0 is selected and the passed output voltage Vg0 is generated, the selection circuit 3 selects the detection voltage Vf0. Similarly, in the case that the output terminal Pg1 is selected and the passed output voltage Vg1 is generated, the selection circuit 3 selects the detection voltage Vf1. Similarly, in the case that the output terminal Pg2 is selected and the passed output voltage Vg2 is generated, the selection circuit 3 selects the detection voltage Vf2. Similarly, in the case that the output terminal Pg3 is selected and the passed output voltage Vg3 is generated, the selection circuit 3 selects the detection voltage Vf3.

The operational amplifier circuit 2 receives the selected detection voltage Vf at the inverting input terminal thereof and generates the output voltage Vo so that the difference between the reference voltage Vref and the selected detection voltage Vf becomes small. More specifically, in the case that the selected detection voltage Vf is lower than the reference voltage Vref, the output voltage Vo rises and the selected detection voltage Vf rises, whereby the difference between the reference voltage Vref and the selected detection voltage Vf becomes small. Conversely, in the case that the selected detection voltage Vf is higher than the reference voltage Vref, the output voltage Vo lowers and the selected detection voltage Vf lowers, whereby the difference between the reference voltage Vref and the selected detection voltage Vf becomes small.

The operational amplifier circuit 2 has the function of an error amplifier circuit that generates an error amplification voltage, that is, a voltage monotonically increasing with respect to an error voltage obtained by subtracting the selected detection voltage Vf from the reference voltage Vref and having a predetermined voltage when the error voltage is zero. The operational amplifier circuit 2 further has the function of a current amplifier circuit that current-amplifies the error amplification voltage to generate the output voltage Vo. In other words, the operational amplifier circuit 2 further has the function of a power amplifier circuit that power-amplifies the error amplification voltage to generate the output voltage Vo.

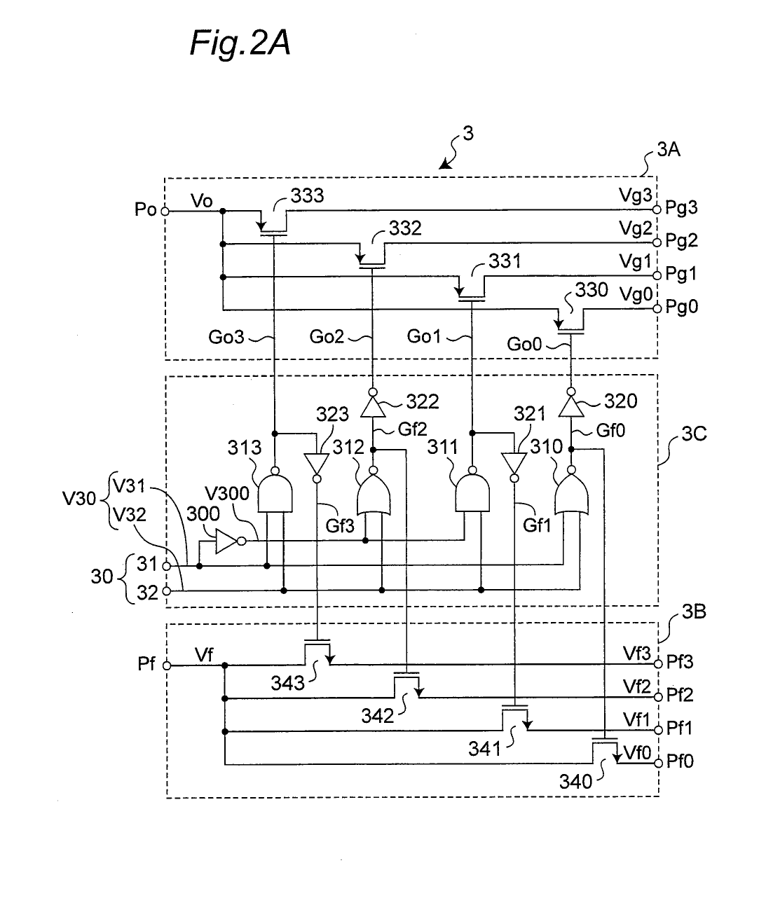

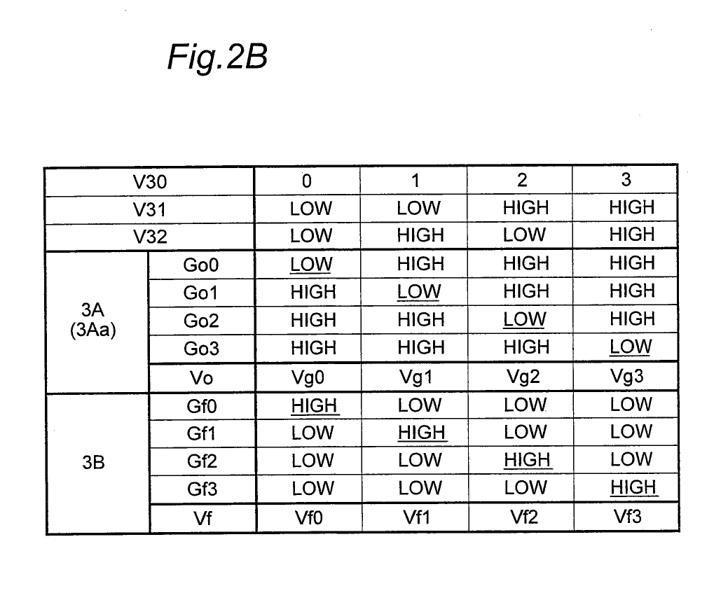

FIG. 2A is a detailed circuit diagram showing the selection circuit 3. The selection circuit 3 includes an output selection circuit 3A, an input selection circuit 3B and a selection control circuit 3C. The selection control circuit 3C receives the control signal V30 through the control terminal 30 and controls the output selection circuit 3A and the input selection circuit 3B on the basis of the control signal V30. The output selection circuit 3A selects either one of the output terminals Pg0 to Pg3, and passes the output voltage Vo through the selected output terminal to generate one of the passed output voltages Vg0 to Vg3. The input selection circuit 3B selects one of the detection voltages Vf0 to Vf3 at the input terminals Pf0, Pf1, Pf2 and Pf3, corresponding to the passed output voltages Vg0 to Vg3 to be generated, respectively, thereby generating the selected detection voltage Vf at the output terminal Pf of the selection circuit 3.

The selection control circuit 3C includes an inverter 300, a NOR circuit 310, a NAND circuit 311, a NOR circuit 312, a NAND circuit 313, and inverters 320, 321, 322 and 323. The control signal V30 at the control terminal 30 includes a control signal V31 at a terminal 31 and a control signal V32 at a terminal 32. The inverter 300 generates an inverted control signal V300 obtained by inverting the control signal V31. The NOR circuit 310 generates a gate signal Gf0 representing the NOR of the control signal V31 and the control signal V32. The NAND circuit 311 generates a gate signal Go1 representing the NAND of the control signal V32 and the inverted control signal V300. The NOR circuit 312 generates a gate signal Gf2 representing the NOR of the inverted control signal V300 and the control signal V32. The NAND circuit 313 generates a gate signal Go3 representing the NAND of the control signal V31 and the control signal V32. The inverter 320 generates a gate signal Go0 representing the NOT of the gate signal Gf0. The inverter 321 generates a gate signal Gf1 representing the NOT of the gate signal Go1. The inverter 322 generates a gate signal Go2 representing the NOT of the gate signal Gf2. The inverter 323 generates a gate signal Gf3 representing the NOT of the gate signal Go3.

FIG. 2B is a relationship diagram showing a selection relationship in the selection circuit 3. When the control signal V30 changes from 0 to 3, the control signal V31 and the control signal V32 each have a value obtained by binary-coding the control signal V30 as shown in FIG. 2B. In the case that the control signal V30 is 0, only the gate signal Go0 (underlined) in the output selection circuit 3A becomes low level, and only the gate signal Gf0 (underlined) in the input selection circuit 3B becomes high level. In the case that the control signal V30 is 1, only the gate signal Go1 in the output selection circuit 3A becomes low level, and only the gate signal Gf1 in the input selection circuit 3B becomes high level. In the case that the control signal V30 is 2, only the gate signal Go2 in the output selection circuit 3A becomes low level, and only the gate signal Gf2 in the input selection circuit 3B becomes high level. In the case that the control signal V30 is 3, only the gate signal Go3 in the output selection circuit 3A becomes low level, and only the gate signal Gf3 in the input selection circuit 3B becomes high level.

The output selection circuit 3A includes a P-channel MOS (metal oxide semiconductor) transistor 330, a P-channel MOS transistor 331, a P-channel MOS transistor 332 and a P-channel MOS transistor 333. The source terminals of the P-channel MOS transistors 330, 331, 332 and 333 are all connected to the input terminal Po, and the drain terminals of the P-channel MOS transistors 330 to 333 are connected to the output terminals Pg0 to Pg3, respectively. The gate terminals of the P-channel MOS transistors 330, 331, 332 and 333 are controlled by the gate signals Go0, Go1 Go2 and Go3, respectively.

In the case that the control signal V30 is 0, only the P-channel MOS transistor 330 is turned ON. At this time, the P-channel MOS transistor 330 passes the output voltage Vo at the input terminal Po and generates the passed output voltages Vg0 at the selected output terminal Pg0. In the case that the control signal V30 is 1, only the P-channel MOS transistor 331 is turned ON. At this time, the P-channel MOS transistor 331 passes the output voltage Vo at the input terminal Po and generates the passed output voltages Vg1 at the selected output terminal Pg1. In the case that the control signal V30 is 2, only the P-channel MOS transistor 332 is turned ON. At this time, the P-channel MOS transistor 332 passes the output voltage Vo at the input terminal Po and generates the passed output voltages Vg2 at the selected output terminal Pg2. In the case that the control signal V30 is 3, only the P-channel MOS transistor 333 is turned ON. At this time, the P-channel MOS transistor 333 passes the output voltage Vo at the input terminal Po and generates the passed output voltages Vg3 at the selected output terminal Pg3.

The input selection circuit 3B includes an N-channel MOS transistor 340, an N-channel MOS transistor 341, an N-channel MOS transistor 342 and an N-channel MOS transistor 343. The source terminals of the N-channel MOS transistors 340 to 343 are connected to the input terminals Pf0 to Pf3, respectively, and the drain terminals of the P-channel MOS transistors 340 to 343 are all connected to the output terminal Pf. The gate terminals of the N-channel MOS transistors 340, 341, 342 and 343 are controlled by the gate signals Gf0, Gf1 Gf2 and Gf3, respectively.

In the case that the control signal V30 is 0, only the N-channel MOS transistor 340 is turned ON. At this time, the N-channel MOS transistor 340 passes the detection voltage Vf0 at the input terminal Pf0 and generates the selected detection voltage Vf at the output terminal Pf. In the case that the control signal V30 is 1, only the N-channel MOS transistor 341 is turned ON. At this time, the N-channel MOS transistor 341 passes the detection voltage Vf1 at the input terminal Pf1 and generates the selected detection voltage Vf at the output terminal Pf. In the case that the control signal V30 is 2, only the N-channel MOS transistor 342 is turned ON. At this time, the N-channel MOS transistor 342 passes the detection voltage Vf2 at the input terminal Pf2 and generates the selected detection voltage Vf at the output terminal Pf. In the case that the control signal V30 is 3, only the N-channel MOS transistor 343 is turned ON. At this time, the N-channel MOS transistor 343 passes the detection voltage Vf3 at the input terminal Pf3 and generates the selected detection voltage Vf at the output terminal Pf.

Returning to FIG. 1, in the case that each of the detection voltages Vf0 to Vf3 is selected by the selection circuit 3, the detection voltage becomes equal to the selected detection voltage Vf. The selected detection voltage Vf operates so as to become approximately equal to the reference voltage Vref in the operational amplifier circuit 2. Hence, Expressions 1, 2, 3 and 4 can be converted into Expressions 5, Expression 6, Expression 7 and Expression 8, respectively. In other words, in the case that each of the selected output voltages Vo0 to Vo3 is selected by the selection circuit 3, the selected output voltages Vo0 to Vo3 are represented by Expressions 5 to 8, respectively. The selected output voltages Vo0 to Vo3 in Expressions 5 to 8 can all be equal to or higher than the reference voltage Vref and different from one another.

Vo0=Vref×(R40+R41)/R41 (5)

Vo1=Vref×(R42+R43)/R43 (6)

Vo2=Vref×(R44+R45)/R45 (7)

Vo3=Vref×(R46+R47)/R47 (8)

In the case that the output terminal Pg0 is not selected in the selection circuit 3, no current flows in the resistors 40 and 41, and the selected output voltage Vo0 is held at a zero potential (in other words, the ground potential). Similarly, in the case that the output terminals Pg1 to Pg3 are not selected in the selection circuit 3, the selected output voltages Vo1 to Vo3 respectively corresponding to the output terminals are held at a zero potential.

As described above, the operational amplifier circuit 2 has the functions of an error amplifier circuit and a current amplifier circuit. The voltage supply circuit 6 includes four auxiliary voltage supply circuits that generate the selected output voltages Vo0 to Vo3 at the output terminal Po0 to Po3, respectively, using this one operational amplifier circuit (the operational amplifier circuit 2). In other words, the four auxiliary voltage supply circuits for generating the selected output voltages Vo0 to Vo3 share the use of the operational amplifier circuit 2 as a circuit having the functions of an error amplifier circuit and a current amplifier circuit. Among these circuits, the auxiliary voltage supply circuits for generating the selected output voltages Vo1 to Vo3 can supply the voltages to the load circuits L1 to L3, respectively. The auxiliary voltage supply circuit for generating the selected output voltage Vo0 is also referred to as a supply-stop state auxiliary voltage supply circuit, and the auxiliary voltage supply circuits for generating the selected output voltages Vo1 to Vol3 are also referred to as supply state auxiliary voltage supply circuits.

In the case that the voltage supply circuit 6 is in the supply stop state, the selection circuit 3 selects the output terminal Pg0 and the input terminal Pf0 and generates the selected output voltage Vo0 represented by Expression 5 at the dummy output terminal Po0. In the supply stop state of the voltage supply circuit 6, the path from the input terminal Po to the inverting input terminal of the operational amplifier circuit 2 through the output terminal Pg0, the dummy output terminal Po0, the resistor 40, the input terminal Pf0 and the output terminal Pf is referred to as a supply-stop state feedback path. Even in the supply stop state of the voltage supply circuit 6, the operational amplifier circuit 2 is in a steady operation state by using the supply-stop state feedback path as described above. Furthermore, the selected output voltages Vo1 to Vo3 are held at a zero potential. Next, in the supply state of the voltage supply circuit 6, when the selection circuit 3 selects the output terminal Pg2 and the input terminal Pf2 to operate the load L2, for example, among the load circuits L1 to L3, the selected detection voltage Vf changes from the reference voltage Vref to a zero potential. At this time, the difference between the selected detection voltage Vf at the inverting input terminal and the reference voltage Vref at the non-inverting input terminal is sufficiently large. Hence, the voltage supply circuit 6 can quickly raise the selected output voltage Vo2 so that the selected output voltage Vf is quickly brought close to the reference voltage Vref by using the operational amplifier circuit 2 being in the operation state at all times. In other words, the voltage supply circuit 6 can quickly raise each of the selected output voltages Vo0 to Vo3 by switching the supply-stop state auxiliary voltage supply circuit to one of the supply state auxiliary voltage supply circuits using the selection circuit 3.

With the use of the selection circuit 3 as described above, in the case that voltages different from one another are supplied to two or more load circuits, i.e., the load circuits L1 to L3, only one voltage at a time, the voltage supply circuit 6 according to the first embodiment can be configured by using only one operational amplifier circuit (the operational amplifier circuit 2). Hence, the size of the circuit can be reduced, and the power consumption and cost thereof can also be reduced. Furthermore, by setting the operational amplifier circuit 2 at its operation state at all times by providing the supply-stop state feedback path, the voltage supply circuit 6 can quickly raise the voltage to be supplied in the case that the voltage is started to be supplied subsequently to one of the load circuits L1 to L3.

### Second Embodiment

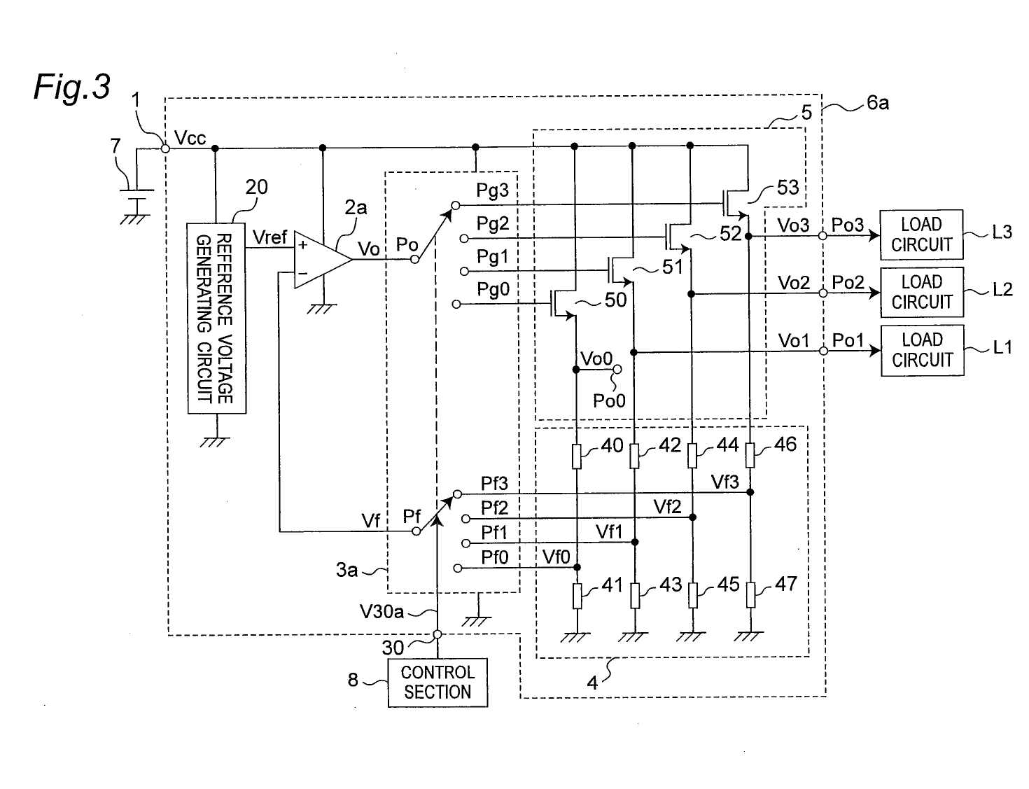

FIG. 3 is a circuit diagram showing a voltage supply circuit 6a. The voltage supply circuit 6a according to the second embodiment is different from the voltage supply circuit 6 (FIG. 1) according to the first embodiment in that a buffer circuit 5 is included additionally, that the operational amplifier circuit 2a of the voltage supply circuit 6a is modified from the operational amplifier circuit 2 and that the selection circuit 3a of the voltage supply circuit 6a is modified from the selection circuit 3. Since the other configurations, operations and effects of the voltage supply circuit 6a are similar to those of the voltage supply circuit 6, descriptions thereof are omitted.

The buffer circuit 5 includes an N-channel MOS transistor 50, an N-channel MOS transistor 51, an N-channel MOS transistor 52 and an N-channel MOS transistor 53. The drain terminals of the N-channel MOS transistors 50, 51, 52 and 53 are all connected to the input terminal 1, and the gate terminals thereof are respectively connected to the output terminals Pg0 to Pg3. The source terminals of the N-channel MOS transistors 50, 51, 52 and 53 are connected to the dummy output terminal Po0, the output terminal Po1, the output terminal Pot and the output terminal Po3, respectively.

The buffer circuit 5 receives the passed output voltages Vg0 to Vg3 at high impedances and outputs the voltages at low impedances, thereby generating the passed output voltages Vo0 to Vo3, respectively. The output terminal Po1 can receive the passed output voltage Vg1 through the N-channel MOS transistor 51 and can output the passed output voltage Vo1 that is lower than the passed output voltage Vg1 by the gate-source voltage of the N-channel MOS transistor 51 to the load circuits L1. Similarly, the output terminal Po2 can receive the passed output voltage Vg2 through the N-channel MOS transistor 52 and can output the passed output voltage Vo2 that is lower than the passed output voltage Vg2 by the gate-source voltage of the N-channel MOS transistor 52 to the load circuits L2. Similarly, the output terminal Po3 can receive the passed output voltage Vg3 through the N-channel MOS transistor 53 and can output the passed output voltage Vo3 that is lower than the passed output voltage Vg3 by the gate-source voltage of the N-channel MOS transistor 53 to the load circuits L3.

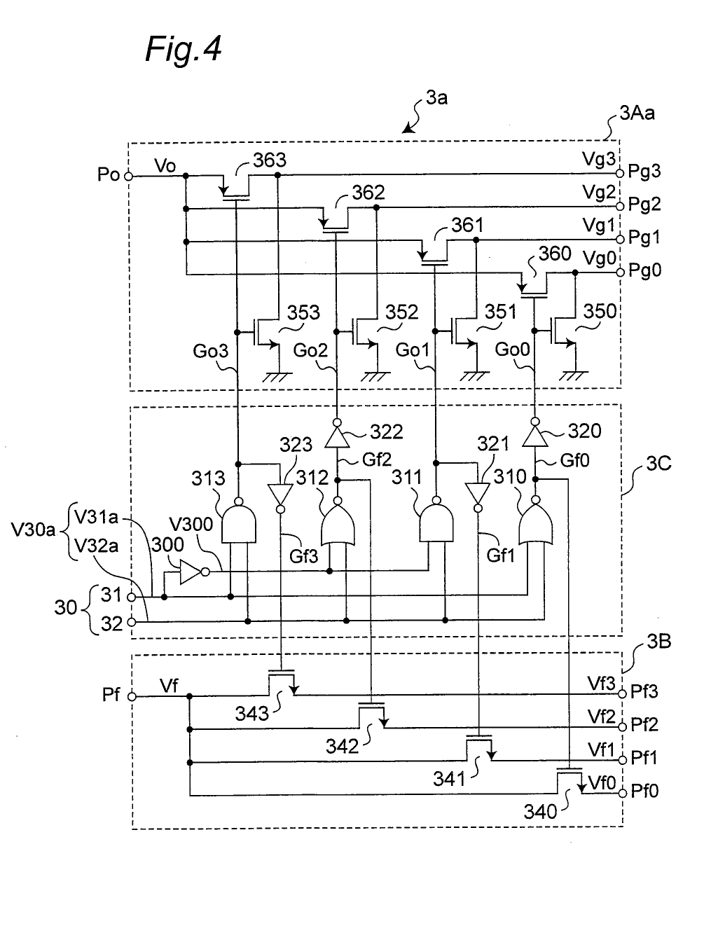

FIG. 4 is a detailed circuit diagram showing the selection circuit 3a. The selection circuit 3a is different from the selection circuit 3 shown in FIG. 2A in that the output selection circuit 3Aa of the selection circuit 3a is modified from the output selection circuit 3A. Since the other configurations, operations and effects of the selection circuit 3a are similar to those of the selection circuit 3, descriptions thereof are omitted.

The output selection circuit 3Aa includes a P-channel MOS transistor 360, a P-channel MOS transistor 361, a P-channel MOS transistor 362, a P-channel MOS transistor 363, an N-channel MOS transistor 350, an N-channel MOS transistor 351, an N-channel MOS transistor 352 and an N-channel MOS transistor 353. The source terminals of the P-channel MOS transistors 360, 361, 362 and 363 are all connected to the input terminal Po, and the drain terminals of the P-channel MOS transistors 360 to 363 are respectively connected to the output terminals Pg0 to Pg3. The gate terminals of the P-channel MOS transistors 360 to 363 are controlled by the gate signals Go0 to Go3, respectively. The source terminals of the N-channel MOS transistors 350 to 353 are all connected to the ground terminal, and the drain terminals of the N-channel MOS transistors 350 to 353 are connected to the output terminals Pg0 to Pg3, respectively. The gate terminals of the N-channel MOS transistors 350 to 353 are controlled by the gate signals Go0 to Go3, respectively.

In the case that the control signal V30 is 0, only the P-channel MOS transistor 360 among the P-channel MOS transistors 360 to 363 is turned ON, and the other P-channel MOS transistors are turned OFF. Furthermore, in the case that the control signal V30 is 0, only the N-channel MOS transistor 350 among the N-channel MOS transistors 350 to 353 is turned OFF, and the other N-channel MOS transistors are turned ON. At this time, the P-channel MOS transistor 360 passes the output voltage Vo at the input terminal Po and generates the passed output voltages Vg0 at the selected output terminal Pg0, and the N-channel MOS transistors 351, 352 and 353 hold the passed output voltages Vg1, Vg2 and Vg3 at a zero potential, respectively.

Similarly, in the case that the control signal V30 is 1, only the P-channel MOS transistor 361 among the P-channel MOS transistors 360 to 363 is turned ON, and the other P-channel MOS transistors are turned OFF. Furthermore, in the case that the control signal V30 is 1, only the N-channel MOS transistor 351 among the N-channel MOS transistors 350 to 353 is turned OFF, and the other N-channel MOS transistors are turned ON. At this time, the P-channel MOS transistor 361 passes the output voltage Vo at the input terminal Po and generates the passed output voltages Vg1 at the selected output terminal Pg1, and the N-channel MOS transistors 350, 352 and 353 hold the passed output voltages Vg0, Vg2 and Vg3 at a zero potential, respectively.

Similarly, in the case that the control signal V30 is 2, only the P-channel MOS transistor 362 among the P-channel MOS transistors 360 to 363 is turned ON, and the other P-channel MOS transistors are turned OFF. Furthermore, in the case that the control signal V30 is 2, only the N-channel MOS transistor 352 among the N-channel MOS transistors 350 to 353 is turned OFF, and the other N-channel MOS transistors are turned ON. At this time, the P-channel MOS transistor 362 passes the output voltage Vo at the input terminal Po and generates the passed output voltages Vg2 at the selected output terminal Pg2, and the N-channel MOS transistors 350, 351 and 353 hold the passed output voltages Vg0, Vg1 and Vg3 at a zero potential, respectively.

Similarly, in the case that the control signal V30 is 3, only the P-channel MOS transistor 363 among the P-channel MOS transistors 360 to 363 is turned ON, and the other P-channel MOS transistors are turned OFF. Furthermore, in the case that the control signal V30 is 3, only the N-channel MOS transistor 353 among the N-channel MOS transistors 350 to 353 is turned OFF, and the other N-channel MOS transistors are turned ON. At this time, the P-channel MOS transistor 363 passes the output voltage Vo at the input terminal Po and generates the passed output voltages Vg3 at the selected output terminal Pg3, and the N-channel MOS transistors 350, 351 and 352 hold the passed output voltages Vg0, Vg1 and Vg2 at a zero potential, respectively.

As described above, in the case that the selection circuit 3a does not select the output terminals Pg0 to Pg3, the selection circuit 3a sets the passed output voltages Vg0 to Vg3 corresponding to the terminals Pg0 to Pg3, respectively, to a zero potential. In the case that the passed output voltages Vg0 to Vg3 of the N-channel MOS transistors 50 to 53 are set to a zero potential, the N-channel MOS transistors are turned OFF. Hence, in the case that the N-channel MOS transistors 50 to 53 are turned OFF, the selected output voltages Vo0 to Vo3 are set to a zero potential.

The operational amplifier circuit 2a has the function of an error amplifier circuit that generates an output voltage Vo, that is, a voltage monotonically increasing with respect to an error voltage obtained by subtracting the selected detection voltage Vf from the reference voltage Vref and having a predetermined voltage when the error voltage is zero. The buffer circuit 5 has the function of a current amplifier circuit that current-amplifies the selected output voltages Vg0 to Vg3 to generate the selected output voltages Vo0 to Vo3, respectively. In other words, the buffer circuit 5 has a function of a power amplifier circuit that power-amplifies the selected output voltages Vg0 to Vg3 to generate the selected output voltages Vo0 to Vo3, respectively.

The voltage supply circuit 6a includes four auxiliary voltage supply circuits that generate the selected output voltages Vo0 to Vo3 at the output terminal Po0 to Po3, respectively, using this one operational amplifier circuit (the operational amplifier circuit 2) and the buffer circuit 5. In other words, the four auxiliary voltage supply circuits for generating the selected output voltages Vo0 to Vo3 share the use of the operational amplifier circuit 2a as a circuit having the function of an error amplifier circuit and use the N-channel MOS transistors 50 to 53 as current amplifier circuits. Among these circuits, the auxiliary voltage supply circuits for generating the selected output voltages Vo1 to Vo3 can supply the voltages to the load circuits L1 to L3, respectively. The auxiliary voltage supply circuit for generating the selected output voltage Vo0 is also referred to as a supply-stop state auxiliary voltage supply circuit, and the auxiliary voltage supply circuits for generating the selected output voltages Vo1 to Vol3 are also referred to as supply state auxiliary voltage supply circuits.

In the case of the voltage supply circuit 6a, the auxiliary voltage supply circuits serve as series regulators. In other words, the voltage supply circuit 6a is formed of four series regulators. The supply-stop state auxiliary voltage supply circuit is also referred to as a supply-stop state series regulator, and the supply state auxiliary voltage supply circuit is also referred to as a supply state series regulator.

In the case that the voltage supply circuit 6a is in the supply stop state, the selection circuit 3a selects the output terminal Pg0 and the input terminal Pf0 and generates the selected output voltage Vo0 represented by Expression 5 at the dummy output terminal Po0. In the supply stop state of the voltage supply circuit 6a, the path from the input terminal Po to the inverting input terminal of the operational amplifier circuit 2a through the output terminal Pg0, the N-channel MOS transistor 50, the dummy output terminal Po0, the resistor 40, the input terminal Pf0 and the output terminal Pf is referred to as a supply-stop state feedback path. Even in the supply stop state of the voltage supply circuit 6a, the operational amplifier circuit 2a is in a steady operation state by using the supply-stop state feedback path as described above. Furthermore, the selected output voltages Vo1 to Vo3 are held at a zero potential. Next, in the supply state of the voltage supply circuit 6a, when the selection circuit 3a selects the output terminal Pg2 and the input terminal Pf2 to operate the load L2, for example, among the load circuits L1 to L3, the selected detection voltage Vf changes from the reference voltage Vref to a zero potential. At this time, the difference between the selected detection voltage Vf at the inverting input terminal and the reference voltage Vref at the non-inverting input terminal is sufficiently large. Hence, the voltage supply circuit 6a can quickly raise the selected output voltage Vo2 so that the selected output voltage Vf is quickly brought close to the reference voltage Vref by using the operational amplifier circuit 2a being in the operation state at all times. In other words, the voltage supply circuit 6a can quickly raise each of the selected output voltages Vo0 and Vo3 by switching the supply-stop state series regulator to one of the supply state series regulators using the selection circuit 3a.

The N-channel MOS transistors 50, 51, 52 and 53 included in the buffer circuit 5 may be P-channel MOS transistors, NPN bipolar transistors or PNP bipolar transistors. In this case, the operational amplifier circuit 2a and the selection circuit 3a included in the voltage supply circuit 6a may be modified depending on the type of the above-mentioned transistors included in the buffer circuit 5.

As described above, with the voltage supply circuit 6a according to the second embodiment, the function thereof can be separated into a function provided for the operational amplifier circuit 2a having the function of an error amplifier circuit and a function provided for the buffer circuit 5 having the function of a current amplifier circuit. Hence, in addition to the effects of the voltage supply circuit 6 according to the first embodiment, the power consumption of the operational amplifier circuit 2a can be reduced in comparison with the operational amplifier circuit 2 according to the first embodiment. Furthermore, each of the N-channel MOS transistors 50 to 53 can be formed to have a semiconductor size suited for the power required for the dummy output terminal Po0 and each of the load circuits L1 to L3. Consequently, the overall power consumption and cost of the voltage supply circuit 6a can be reduced.

### Third Embodiment

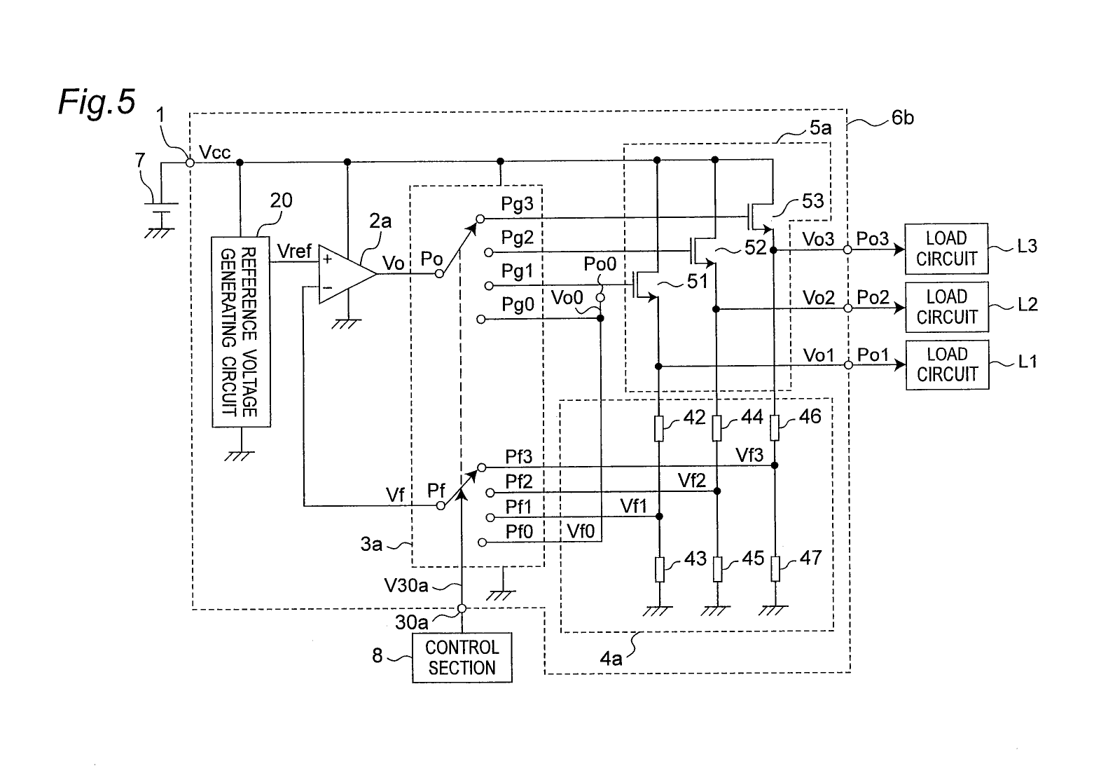

FIG. 5 is a circuit diagram showing a voltage supply circuit 6b. The voltage supply circuit 6b according to the third embodiment is different from the voltage supply circuit 6a (FIG. 3) according to the second embodiment in that the buffer circuit 5a of the voltage supply circuit 6b is modified from the buffer circuit 5 and that the detection circuit 4a of the voltage supply circuit 6b is modified from the detection circuit 4. Since the other configurations, operations and effects of the voltage supply circuit 6b are similar to those of the voltage supply circuit 6a, descriptions thereof are omitted.

The buffer circuit 5a includes the N-channel MOS transistors 51 to 53, but does not include the N-channel MOS transistor 50. The detection circuit 4a includes the resistors 42 to 47, but does not include the resistors 40 and 41. As a result, in the supply-stop state feedback path, the output terminal Pg0 is directly connected (short-circuited) to the input terminal Pf0. Moreover, the supply-stop state feedback path is insulated from the ground terminal. In the detection circuit 4a, the passed output voltage Vg0 serves as the detection voltage Vf0.

The voltage supply circuit 6b is formed of three supply state series regulators for generating the selected output voltages Vo1 to Vo3 at the output terminals Po1 to Po3 by using one operational amplifier circuit (the operational amplifier circuit 2a) and the buffer circuit 5a. The voltage supply circuit 6b does not include a supply-stop state series regulator. In the supply stop state, the output terminal Pg0 is directly connected to the inverting input terminal of the operational amplifier circuit 2a by the supply-stop state feedback path. Hence, the operational amplifier circuit 2a operates as a buffer circuit.

As described above, the voltage supply circuit 6b according to the third embodiment can obtain effects similar to those of the voltage supply circuit 6a according to the second embodiment and can eliminate the use of the N-channel MOS transistor 50 and the resistors 40 and 41, whereby the overall power consumption and cost of the voltage supply circuit 6b can be reduced further in comparison with the voltage supply circuit 6a.

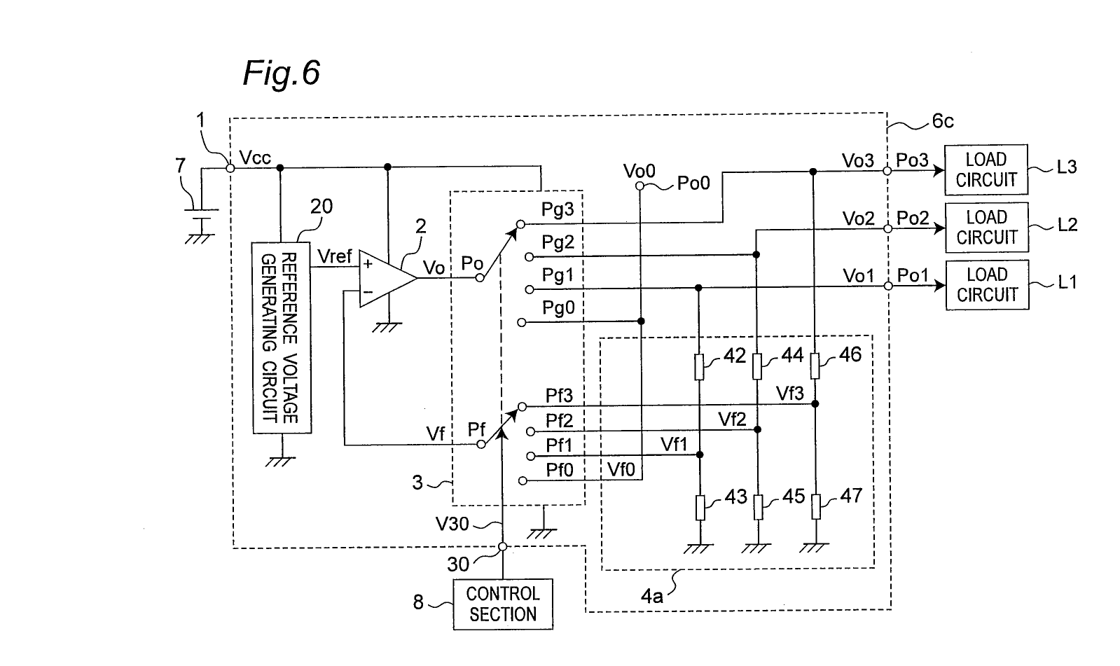

As in the case that the voltage supply circuit 6b shown in FIG. 5 is configured on the basis of the voltage supply circuit 6a shown in FIG. 3, a voltage supply circuit 6c shown in FIG. 6 may be configured on the basis of the voltage supply circuit 6 shown in FIG. 1 by eliminating the resistors 40 and 41. As in the case of the supply-stop state of the voltage supply circuit 6b, in the supply stop state of the voltage supply circuit 6c, the output terminal Pg0 is directly connected to the inverting input terminal of the operational amplifier circuit 2 by the supply-stop state feedback path. Hence, the operational amplifier circuit 2 operates as a buffer circuit.

### Summary of the Embodiments

In the above-mentioned embodiments, the number of the output terminals is three, i.e., the output terminals Po1 to Po3. However, the number may be two or larger. In addition, the supply-stop state feedback path passing through the dummy output terminal may be omitted.

With the use of the selection circuit 3 as described above, in the case that voltages different from one another are supplied to two or more load circuits, i.e., the load circuits L1 to L3, only one voltage at a time, the voltage supply circuit 6 can be configured by using only one operational amplifier circuit (the operational amplifier circuit 2). Hence, the size of the circuit can be reduced, and the power consumption and cost thereof can also be reduced. Furthermore, by setting the operational amplifier circuit 2 at its operation state at all times by providing the supply-stop state feedback path, the voltage supply circuit 6 can quickly raise the voltage to be supplied in the case that the voltage is started to be supplied subsequently to one of the load circuits L1 to L3.

Moreover, with the voltage supply circuit 6a, the function thereof can be separated into a function provided for the operational amplifier circuit 2a having the function of an error amplifier circuit and a function provided for the buffer circuit 5 having the function of a current amplifier circuit. Hence, in addition to the effects of the voltage supply circuit 6, the power consumption of the operational amplifier circuit 2a can be reduced in comparison with the operational amplifier circuit 2. Furthermore, each of the N-channel MOS transistors 50 to 53 can be formed to have a semiconductor size suited for the power required for the dummy output terminal Po0 and each of the load circuits L1 to L3. Consequently, the overall power consumption and cost of the voltage supply circuit 6a can be reduced.

Moreover, the voltage supply circuit 6b can obtain effects similar to those of the voltage supply circuit 6a and can eliminate the use of the N-channel MOS transistor 50 and the resistors 40 and 41, whereby the overall power consumption and cost of the voltage supply circuit 6b can be reduced further in comparison with the voltage supply circuit 6a.

Examples all embodying the present invention are described in the above descriptions regarding the embodiments. However, the present invention is not limited to these examples but can be applied to various examples that can be configured easily by those skilled in the art using the technology according to the present invention.

The disclosure of Japanese Patent Application No. 2009-045977 filed Feb. 27, 2009 including specification, drawings and claims is incorporated herein by reference in its entirety.

What is claimed is:

1. A voltage supply circuit comprising:
a reference voltage generating circuit operable to generate a predetermined reference voltage;
an operational amplifier circuit operable to generate an output voltage on the basis of said reference voltage;
a selection circuit having at least two first terminals and controlled on the basis of a control signal from a control section to select one of said first terminals and to generate a passed output voltage representing said output voltage passed through said first terminal selected;
a second terminal operable to receive said passed output voltage and capable of outputting said passed output voltage to a load circuit; and
a detection circuit operable to detect a magnitude of said passed output voltage and to generate a detection voltage, wherein
said selection circuit is controlled on the basis of said control signal, selects a voltage corresponding to said passed output voltage generated from among at least two of said detection voltages and generates a selected detection voltage representing said detection voltage selected, and
said operational amplifier circuit decreases the difference between said reference voltage and said selected detection voltage.

2. The voltage supply circuit according to claim 1, wherein
said selection circuit generates a plurality of passed output voltages,
said second terminal does not receive one predetermined voltage of said plurality of passed output voltages.

3. The voltage supply circuit according to claim 2, wherein said detection circuit uses said predetermined passed output voltage as said detection voltage.

4. The voltage supply circuit according to claim 1, wherein said detection circuit performs detection by dividing said passed output voltage.

5. The voltage supply circuit according to claim 4, wherein said detection circuit includes two resistors connected in series with each other between said first terminal and a ground terminal and detects the voltage at the connection point of said two resistors.

6. The voltage supply circuit according to claim 1, further comprising a buffer circuit that receives said passed output voltage at a high impedance and outputs said passed output voltage at a low impedance, wherein
said second terminal receives said passed output voltage through said buffer circuit.

7. The voltage supply circuit according to claim 6, wherein said detection circuit detects the magnitude of said passed output voltage received through said buffer circuit.

8. The voltage supply circuit according to claim 6, wherein
said buffer circuit includes a transistor,
said transistor receives said passed output voltage at a control terminal of said transistor and outputs the received voltage from ether one of a source terminal or an emitter terminal of said transistor.
